(19) United States
(12) Patent Application Publication
(10) Pub. No.: US 2020/0087599 A1
(43) Pub. Date: Mar. 19, 2020

(54) CLEANING FLUID COMPOSITIONS AND METHODS OF MAKING AND USING THE SAME

(71) Applicant: PPG INDUSTRIES OHIO, INC., Cleveland, OH (US)

(72) Inventors: Shuyu Fang, Pittsburgh, PA (US); Eldon L. Decker, Gibsonia, PA (US); Kristen Kruszewski, Pittsburgh, PA (US)

(21) Appl. No.: 16/132,874

(22) Filed: Sep. 17, 2018

(51) Int. Cl. C11D 7/26; C11D 7/50; C11D 7/04

(52) U.S. Cl. CPC C11D 7/261; C11D 11/0035; C11D 7/04; C11D 7/5022

(57) ABSTRACT

A cleaning fluid composition, a method of manufacture of the fluid composition, and a method of use thereof are provided. The fluid composition comprises 10% to 50% by weight of an alcohol based on the total weight of the fluid composition, 2% to 40% by weight of a co-solvent based on the total weight of the fluid composition, and at least 20% by weight of water based on the total weight of the fluid composition. The co-solvent is miscible with water, the fluid composition is substantially free of ethylene glycol and methanol, and the fluid composition has a viscosity less than or equal to 45 cP at −25 degrees Celsius and a freezing point less than −25 degrees Celsius.

### FIELD

The present disclosure relates to cleaning fluid compositions and methods of making and using the same.

### BACKGROUND

Many devices include surfaces that may require regular cleaning to maintain proper performance or visibility. For example, automobiles, including autonomous vehicles, have various sensors such as Light Imaging, Detection, and Ranging (LIDAR), cameras, near infrared detectors, and/or lasers that can accumulate airborne and road debris that reduce performance of the sensors. Additionally, a vehicle windshield may accumulate airborne and road debris that reduce operator visibility.

There is an ongoing need to provide improved compositions and methods to maintain clean surfaces and provide good visibility during the operation of devices, such as autonomous vehicles.

### SUMMARY

In one aspect, the present disclosure provides a cleaning fluid composition. The fluid composition comprises (a) 10% to 50% by weight of an alcohol based on the total weight of the fluid composition, (b) 2% to 40% by weight of a co-solvent based on the total weight of the fluid composition, and (c) at least 20% by weight of water based on the total weight of the fluid composition. The co-solvent is miscible with water, the fluid composition is substantially free of ethylene glycol and methanol, and the fluid composition has a viscosity less than or equal to 45 cP at −25 degrees Celsius and a freezing point less than −25 degrees Celsius.

In another aspect, the present disclosure provides a method for manufacture of a cleaning fluid composition. The method comprises (a) adding 10% to 50% by weight of an alcohol based on the total weight of the fluid composition, (b) adding at least 20% by weight of water based on the total weight of the fluid composition, and (c) adding 2% to 40% by weight of a co-solvent based on the total weight of the fluid composition. The co-solvent is miscible with water, the fluid composition is substantially free of ethylene glycol and methanol, and the fluid composition has a viscosity less than or equal to 45 cP at −25 degrees Celsius and a freezing point less than −25 degrees Celsius.

In another aspect, the present disclosure provides a cleaning method. The cleaning method comprises (i) applying a cleaning fluid composition to a surface of a substrate. The fluid composition comprises (a) 10% to 50% by weight of an alcohol based on the total weight of the fluid composition, (b) 2% to 40% by weight of a co-solvent based on the total weight of the fluid composition, and (c) at least 20% by weight of water based on the total weight of the fluid composition. The co-solvent is miscible with water, the fluid composition is substantially free of ethylene glycol and methanol, and the fluid composition has a viscosity less than or equal to 45 cP at −25 degrees Celsius and a freezing point less than −25 degrees Celsius.

It is understood that the inventions described in this specification are not limited to the examples summarized in this Summary. Various other aspects are described and exemplified herein.

### DETAILED DESCRIPTION

Certain exemplary aspects of the present disclosure will now be described to provide an overall understanding of the principles of the composition, function, manufacture, and use of the compositions and methods disclosed herein. One or more examples of these aspects are illustrated in the accompanying drawing. Those of ordinary skill in the art will understand that the compositions and methods specifically described herein are non-limiting exemplary aspects and that the scope of the various examples of the present invention is defined solely by the claims. The features illustrated or described in connection with one exemplary aspect may be combined with the features of other aspects. Such modifications and variations are intended to be included within the scope of the present invention.

Reference throughout the specification to “various examples,” “some examples,” “one example,” or “an example”, or the like, means that a particular feature, structure, or characteristic described in connection with the example is included in at least one example. Thus, appearances of the phrases “in various examples,” “in some examples,” “in one example”, or “in an example”, or the like, in places throughout the specification are not necessarily all referring to the same example. Furthermore, the particular features, structures, or characteristics may be combined in any suitable manner in one or more examples. Thus, the particular features, structures, or characteristics illustrated or described in connection with one example may be combined, in whole or in part, with the features structures, or characteristics of one or more other examples without limitation. Such modifications and variations are intended to be included within the scope of the present examples.

In this specification, unless otherwise indicated, all numerical parameters are to be understood as being prefaced and modified in all instances by the term “about”, in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Also, any numerical range recited herein includes all sub-ranges subsumed within the recited range. For example, a range of “1 to 10” includes all sub-ranges between (and including) the recited minimum value of 1 and the recited maximum value of 10, that is, having a minimum value equal to or greater than 1 and a maximum value equal to or less than 10. Any maximum numerical limitation recited in this specification is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All ranges are inherently described in this specification.

The grammatical articles “a”, “an”, and “the”, as used herein, are intended to include “at least one” or “one or more”, unless otherwise indicated, even if “at least one” or “one or more” is expressly used in certain instances. Thus, the articles are used herein to refer to one or more than one (i.e., to “at least one”) of the grammatical objects of the article. Further, the use of a singular noun includes the plural, and the use of a plural noun includes the singular, unless the context of the usage requires otherwise.

As used herein a “cleaning process” means a process that employs a cleaning fluid as described herein that reduces and/or eliminates debris such as, for example, dirt, dust, a particle, an oil, ice, snow, bird excrement, an insect, and the like from a surface of a device, optionally aided by mechanical action, as further described below. As used herein, “cleaning fluid” means any composition that includes a chemical component that is capable of reducing and/or eliminating debris from a surface when applied to the surface. For example, a component of the fluid composition can be water, an alcohol, a co-solvent, ammonia, a salt, and combinations thereof.

As used herein “cleaning fluid composition” and “fluid composition” are interchangeable and have the same meaning.

The fluid compositions described in the present disclosure can be substantially free, and may be essentially free, of certain components such as methanol and ethylene glycol. With respect to these components and as used herein, the fluid composition of the present disclosure is said to be “substantially free” of a component if that component is present in an amount less than 2% by weight based on the total weight of the fluid composition. A component can be present in an amount less than 1% by weight based on the total weight of the fluid composition. The fluid composition of the present disclosure is said to be “essentially free” of a component if that component is present in an amount less than 0.6% by weight based on the total weight of the fluid composition. A component can be present in an amount less than 0.3% by weight, less than 0.1% by weight, or less than 0.01% by weight based on the total weight of the fluid composition. Such compositions that are essentially free of a component may include derivatives or residues of the stated component, but such component is not intentionally added but may be present in trace amounts as specified above because of unavoidable contamination from the environment. The fluid composition of the present disclosure is said to be “completely free” of a component if that component is not present, i.e., 0.00% by weight of the fluid composition based on the total weight of the fluid composition.

Vehicles are designed to operate throughout the world. The localities in which vehicles operate may have vastly different natural environmental conditions, such as temperature, governmental environmental conditions, such as legal restrictions, and the like, that present unique challenges for safe operation of the vehicles. For example, in order to safely operate in the localities, the vehicles may have to use cleaning fluid compositions to keep the windshield clean and free of debris. Governmental authorities typically enact laws restricting the type of chemicals that may be used in cleaning fluid compositions. For example, regarding cleaning fluid compositions that include methanol, the European Union recently adopted a standard for windscreen washing and defrosting fluids in Annex XVII to Regulation (EC) No 1907/2006 of the European Parliament and of the Council concerning the Registration, Evaluation, Authorization, and Restriction of Chemicals (REACH) that state “Methanol CAS No 67-56-1 EC No. 200-659-6 [s]hall not be placed on the market to the general public after 9 May 2019 in windscreen washing or defrosting fluids, in a concentration equal to or greater than [0.6]% by weight.” Typically, compositions that do not contain methanol have a high viscosity at low temperatures which may be unsuitable for some cleaning processes. Similarly, there have been restrictions placed on the use and amounts of ethylene glycol in cleaning fluid compositions. Thus, the present disclosure provides a cleaning fluid composition comprising an alcohol, a co-solvent, and water that is substantially free of methanol and ethylene glycol with specific viscosity parameters that can satisfy the current natural or governmental environmental conditions in many localities throughout the world. The fluid composition can have a viscosity of less than 45 centipoise (cP) at −25 Celsius and a freezing point of less than −25 degrees Celsius which can enable a cleaning process and/or can enable removal of the fluid composition after the cleaning process at or below an environmental temperature of −25 degrees Celsius. The viscosity of the fluid composition can be measured using an Anton Paar rheometer MCR302 with a CP-50 spindle at the respective temperature. The fluid composition can comprise a liquid or the fluid composition can consist of a liquid.

The alcohol content of the fluid compositions of the present disclosure can reduce the freezing point of the fluid composition and/or can reduce the viscosity of the fluid composition. The alcohol component can also facilitate the removal of debris from a surface of the device, such as a vehicle. The fluid compositions of the present disclosure can comprise 10% or greater by weight of the alcohol based on the total weight of the fluid composition, such as, 25% or greater by weight of the alcohol, 30% or greater by weight of the alcohol, or 40% or greater by weight of the alcohol, all based on the total weight of the fluid composition. The fluid compositions of the present disclosure can comprise 50% or lower by weight of the alcohol based on the total weight of the fluid composition, such as 45% or lower by weight of the alcohol, 40% or lower by weight of the alcohol, 30% or lower by weight of the alcohol, or 20% or lower by weight of the alcohol, all based on the total weight of the fluid composition. The fluid compositions of the present disclosure can comprise 10% to 50% by weight of the alcohol based on the total weight of the fluid composition, such as 10% to 20% by weight of the alcohol, 10% to 30% by weight of the alcohol, 10% to 40% by weight of the alcohol, 25% to 40% by weight of the alcohol, 25% to 45% by weight of the alcohol, 25% to 50% by weight of the alcohol, 30% to 50% by weight of the alcohol, or 40% to 50% by weight of the alcohol, all based on the total weight of the fluid composition. The alcohol can be at least one of ethanol, 1-propanol, or 2-propanol. The fluid composition can be substantially free of methanol. The fluid composition can be essentially free of methanol and may, for example, be completely free of methanol.

The co-solvent content of the fluid compositions of the present disclosure can reduce the freezing point of the fluid composition and/or can reduce the viscosity of the fluid composition. The co-solvent component can also facilitate the removal of debris from a surface of the device. The fluid compositions of the present disclosure can comprise 2% or greater by weight of the co-solvent based on the total weight of the fluid composition such as, 5% or greater by weight of the co-solvent, 20% or greater by weight of the co-solvent, or 25% or greater by weight of the co-solvent, all based on the total weight of the fluid composition. The fluid compositions of the present disclosure can comprise 40% or lower by weight of the co-solvent based on the total weight of the fluid composition such as, 35% or lower by weight of the co-solvent, 30% or lower by weight of the co-solvent, 20% or lower by weight of the co-solvent, or 10% or lower by weight of the co-solvent, all based on the total weight of the fluid composition. The fluid compositions of the present disclosure can comprise 2% to 40% by weight of the co-solvent based on the total weight of the fluid composition such as, 2% to 10% by weight of the co-solvent, 2% to 20% by weight of the co-solvent, 2% to 30% by weight of the co-solvent, 5% to 20% by weight of the co-solvent, 20% to 40% by weight of the co-solvent, or 25% to 35% by weight of the co-solvent, all based on the total weight of the fluid composition. The co-solvent can be miscible with water. The co-solvent can be at least one of a glycol ether and a ketone. The glycol ether can comprise, for example, at least one of propylene glycol methyl ether, dipropylene glycol methyl ether acetate, ethylene glycol n-butyl ether acetate, propylene glycol n-butyl ether, and dipropylene glycol dimethyl ether. The ketone can be, for example, acetone, methyl ethyl ketone (e.g., butanone), methyl isobutyl ketone, di-isobutyl ketone, and diacetone alcohol. The fluid compositions of the present disclosure can be substantially free of ethylene glycol. The fluid composition can be essentially free of ethylene glycol and may, for example, be completely free of ethylene glycol. The co-solvent may not be water.

The water content of the fluid composition of the present disclosure can facilitate the removal of debris from a surface. The water can be various types of water such as, for example, at least one of de-ionized water, distilled water, reverse osmosis treated water, filtered water, sterile water, and tap water. The fluid compositions of the present disclosure can comprise at least 20% by weight water based on the total weight of the fluid composition such as, 30% or greater by weight water, 40% or greater by weight of water, 50% or greater by weight of water, 60% or greater by weight of water, or 70% or greater by weight of water, all based on the total weight of the fluid composition. The fluid compositions of the present disclosure can comprise 80% or lower by weight of water based on the total weight of the fluid composition such as, 70% or lower by weight of water, 60% or lower by weight of water, 50% or lower by weight of water, or 40% or lower by weight of water, all based on the total weight of the fluid composition. The fluid compositions of the present disclosure can comprise 20% to 80% by weight of water based on the total weight of the fluid composition such as, 20% to 70% by weight of water, 30% to 70% by weight of water, 20% to 40% by weight of water, 30% to 50% by weight of water, 30% to 60% by weight of water, 40% to 70% by weight of water, or 50% to 70% by weight of water, all based on the total weight of the fluid composition.

In order to facilitate a cleaning process and/or removal of the fluid composition after the cleaning process at or below an environmental temperature of −25 degrees Celsius the viscosity of the fluid compositions of the present disclosure can be reduced. For example, the viscosity of the fluid composition can be less than or equal to 45 cP at −25 degrees Celsius such as, less than or equal to 40 cP at −25 degrees Celsius, less than or equal to 35 cP at −25 degrees Celsius, less than or equal to 30 cP at −25 degrees Celsius, or less than or equal to 25 cP at −25 degrees Celsius. The fluid composition can have a viscosity less than or equal to 45 cP at −28 degrees Celsius such as, less than or equal to 40 cP at −28 degrees Celsius, less than or equal to 35 cP at −28 degrees Celsius, less than or equal to 30 cP at −28 degrees Celsius, or less than or equal to 25 cP at −28 degrees Celsius. The freezing point of the fluid composition can be less than −25 degrees Celsius such as, less than −28 degrees Celsius, less than −30 degrees Celsius, or less than 35 degrees Celsius. The viscosity of the fluid composition can be measured using an Anton Paar rheometer MCR302 with a CP-50 spindle at the respective temperature.

The flash point of the fluid compositions can be increased in order to facilitate a cleaning process at or above an environmental temperature of 0 degrees Celsius. For example, the fluid composition may have a flash point of at least 10 degrees Celsius such as, at least 15 degrees Celsius, at least 20 degrees Celsius, at least 25 degrees Celsius, or at least 30 degrees Celsius.

The fluid compositions of the present disclosure can include one or more additional components such as, at least one of ammonia and a salt.

When present, the ammonia component in the fluid compositions of the present disclosure can reduce the freezing point of the fluid composition and/or can reduce the viscosity of the fluid composition. Ammonia can facilitate the removal of debris from a surface. The fluid compositions of the present disclosure can comprise 0.1% or greater by weight ammonia based on the total weight of the fluid composition such as, 1% or greater by weight ammonia, 2% or greater by weight ammonia, or 3% or greater by weight ammonia, all based on the total weight of the fluid composition. The fluid compositions of the present disclosure can comprise 5% or lower by weight ammonia based on the total weight of the fluid composition such as, 3% or lower by weight ammonia, based on the total weight of the fluid composition. The fluid compositions of the present disclosure can comprise 0.1% to 5% by weight ammonia based on the total weight of the fluid composition such as, 0.1% to 1% by weight ammonia, 1% to 5% by weight ammonia, 1% to 3% by weight ammonia, 2% to 5% by weight ammonia, or 3% to 5% by weight ammonia, all based on the total weight of the fluid composition. The ammonia can be added as an impure solution of ammonia. However, the amounts described herein are reported as % by weight of the ammonia component of the ammonia solution.

When present, the salt component in the fluid compositions of the present disclosure can reduce the freezing point of the fluid composition. The fluid compositions of the present disclosure can comprise 1% or greater by weight salt based on the total weight of the fluid composition such as, 2% or greater by weight salt or 10% or greater by weight salt, all based on the total weight of the fluid composition. The fluid compositions of the present disclosure can comprise 20% or lower by weight salt based on the total weight of the fluid composition such as, for example, 15% or lower by weight salt, 10% or lower by weight salt, or 5% or lower by weight salt, all based on the total weight of the fluid composition. The fluid compositions of the present disclosure can comprise 1% to 20% by weight salt based on the total weight of the fluid composition such as, 1% to 5% by weight salt, 2% to 5% by weight salt, 1% to 10% by weight salt, 1% to 15% by weight salt, 10% to 15% by weight salt, or 10% to 20% by weight salt, all based on the total weight of the fluid composition. The salt can comprise any suitable salt such as, for example, a halide, a sulfate, a nitrate, a formate, a carbonate, a phosphate, a perchlorate, and an acetate. The salt can comprise at least one of magnesium chloride, sodium chloride, calcium chloride, potassium chloride, sodium formate, sodium nitrate, sodium carbonate, sodium phosphate, sodium perchlorate, and ammonium acetate.

A method for manufacture of a cleaning fluid composition is provided herein. The method comprises adding an alcohol, water, and a co-solvent in amounts described herein to form the fluid composition. Ammonia and/or salt can be added to form the fluid composition. The components of the fluid composition can be mixed to form a homogenous solution that can comprise a liquid or consist of a liquid.

The components of the fluid compositions of the present disclosure can be combined in any order. For example, the components of the fluid composition can be all combined in a single step or in various steps. A component of the fluid composition can be added in a single addition step or added in multiple addition steps. For example, a first portion of water can be combined with the alcohol component. Thereafter, the co-solvent component can be added to the water and alcohol mixture. The ammonia component and/or a salt component may then be added. Thereafter, a second and remaining portion of the water can be added to form the fluid composition.

A method of cleaning utilizing the fluid composition of the present disclosure is also provided. The method comprises applying the fluid composition to a surface of a substrate, such as a surface of an autonomous vehicle. Applying the fluid composition to a surface can comprise various suitable application methods such as, at least one of spraying, depositing, dipping, rolling, and brushing. The fluid composition according to the present disclosure may be applied to a surface of any substrate known in the art. This substrate may be, for example, metallic or non-metallic. Metallic substrates may include tin, aluminum, steel, such as, tin-plated steel, chromium passivated steel, galvanized steel, or coiled steel, or other coiled metal, and any metallic alloys thereof. Non-metallic substrates may include polymeric, such as plastic, including polyester, polyolefin, polyamide, cellulosic, polystyrene, polyacrylic, poly(ethylene naphthalate), polypropylene, polyethylene, nylon, EVOH, polylactic acid, other “green” polymeric substrates, poly(ethyleneterephthalate) (“PET”), polycarbonate, polycarbonate acrylobutadiene styrene (“PC/ABS”), or polyamide. Other suitable non-metallic substrates may include wood, veneer, wood composite, particle board, medium density fiberboard, cement, stone, glass, ceramic, asphalt, and the like. The substrate can comprise at least one of a camera lens, a headlight lens, a windshield, a window, a floor, a wall, an electronic display, and a mobile device. The application of the fluid composition can remove debris from the substrate so that efficient operation of the device can be achieved.

The application of the fluid composition to the surface can occur at an environmental temperature of less than 60 degrees Celsius such as, less than 50 degrees Celsius, less than 45 degrees Celsius, less than 0 degrees Celsius, less than −10 degrees Celsius, less than −20 degrees Celsius, less than −25 degrees Celsius, and, if the composition has a suitable freezing point, even at an environmental temperature of less than −28 degrees Celsius, less than −30 degrees Celsius, or less than −35 degrees Celsius. The application of the fluid composition to the surface can occur at a temperature −50 degrees Celsius or greater such as, −40 degrees Celsius or greater or −40 degrees Celsius or greater. The application of the fluid composition to the surface can occur at a temperature range of −50 degrees Celsius to 60 degrees Celsius such as, −40 degrees Celsius to 50 degrees Celsius or −40 degrees Celsius to 45 degrees Celsius.

The fluid compositions of the present disclosure can be actively removed (e.g., mechanically removed) from the surface of the device. For example, removal of the fluid composition and/or debris can comprise at least one of wiping the surface and introducing a compressed gas stream to the surface. Where the surface is a windshield, a windshield wiper blade may remove the fluid composition after application to the surface. Where the surface is on a camera lens, the fluid composition can be removed from the camera lens by wiping the lens with a cloth, or a compressed gas stream can be applied to the camera lens to remove the fluid composition. The fluid composition may be allowed to evaporate from the surface without an active removal step.

The cleaning fluid composition according to the present disclosure may be used as at least one of a windscreen washing fluid and a defrosting fluid.

### EXAMPLES

The present disclosure will be more fully understood by reference to the following example, which provides illustrative non-limiting aspects of the invention. The example describes the manufacture and characterization of cleaning fluid compositions for use in a cleaning process.

Cleaning fluid compositions A-N were prepared and tested for freezing point and viscosity. As illustrated in Table 1, the fluid compositions A-N contained alcohol (e.g., ethanol), a co-solvent (e.g., Proglyde™ DMM, methyl ethyl ketone, and/or Dowanol™ PnB), and deionized (DI) water in varying concentrations. Proglyde™ DMM and Dowanol™ PnB are commercially available from The Dow Chemical Company, Midland, Mich. Proglyde™ DMM comprises dipropylene glycol dimethyl ether and Dowanol™ PnB comprises propylene glycol n-butyl ether. Additionally, fluid compositions E-H comprised ammonia, and fluid compositions H, and L-N comprised a salt (e.g., sodium chloride (NaCl)). The components of each fluid composition A-N were combined together and mixed for a time sufficient to homogenize the fluid composition and then tested for viscosity and freezing point.

The viscosity of each fluid composition A-N was measured with an Anton Paar rheometer MCR302 with a CP-50 spindle. The stage of the rheometer was cooled down to −28 degrees Celsius to measure the viscosity. The freezing point was measured with the rheometer by observing the fluid composition as the stage cooled down and determining at which temperature the fluid composition froze. The rheometer was only able to cool to −28 degrees Celsius; thus, any fluid composition that did not freeze was determined to have a freezing point of less than −28 degrees Celsius. The results of the viscosity and freezing point determinations are illustrated in Table 1.

The flash point of fluid compositions B, C, E, H, I, J, and N was determined according to ASTM D3278/D3828/Setaflash Closed Cup Flash Point and the results are illustrated in Table 1.

TABLE 1
Fluid compositions A-N

| | | | | Methyl | | | | | | |
|---|---|---|---|---|---|---|---|---|---|---|
| Cleaning | DI | | Proglyde | ethyl | Dowanol | | | Freezing | Viscosity | Flash |
| Fluid | Water | Ethanol | DMM | Ketone | PnB | Ammonia | NaCl | point | at −28° C. | Point |
| Composition | (wt. %) | (wt. %) | (wt. %) | (wt. %) | (wt. %) | (wt. %) | (wt. %) | (° C.) | (cP) | (° C.) |
| A | 40% | 30% | 28% | — | 2% | — | — | <−28° C. | 47 | — |
| B | 35% | 35% | 28% | — | 2% | — | — | <−28° C. | 39 | 27.8 |
| C | 30% | 40% | 28% | — | 2% | — | — | <−28° C. | 31 | 26.7 |
| D | 54% | 44% | — | — | 2% | — | — | <−28° C. | 46 | — |
| E | 56% | 41% | — | — | 2% | 1% | — | <−28° C. | 43 | 24.5 |
| F | 58% | 38% | — | — | 2% | 2% | — | <−28° C. | 45 | — |
| G | 59% | 36% | — | — | 2% | 3% | — | <−28° C. | 43 | — |
| H | 69% | 25% | — | — | 2% | 3% | 2% | −26.5° C. | Frozen | 27.8 |
| I | 50% | 43% | — | 5% | 2% | — | — | <−28° C. | 29 | 16.7 |
| J | 50% | 38% | — | 10% | 2% | — | — | <−28° C. | 28 | 11.1 |
| K | 50% | 33% | — | 15% | 2% | — | — | <−28° C. | 27 | — |
| L | 65% | 18% | — | — | 2% | — | 15% | <−28° C. | 29 | — |
| M | 65% | 12% | — | — | 2% | — | 10% | <−28° C. | 33 | — |
| N | 70% | 15% | — | — | 2% | — | 13 | <−28° C. | 26 | 30 |

As illustrated in Table 1, the fluid compositions A-G and I-N did not freeze on the rheometer and thus had a freezing point of less than −28 degrees Celsius. Fluid composition H froze on the stage at −26.5 degrees Celsius and the viscosity was not measurable at −28 degrees Celsius. The fluid compositions A-N exhibited freezing points which are at a temperature equal to or less than −25 degrees Celsius.

Fluid compositions B, C, E-G, and I-N had a viscosity of less than or equal to 45 cP at −28 degrees Celsius. It is believed that all of fluid compositions A-N exhibit a viscosity of less than or equal to 45 cP at −25 degrees Celsius based on the viscosity measurements at −28 degrees Celsius.

Fluid compositions B, C, and I-N had a viscosity of less than or equal to 40 cP at −28 degrees Celsius. Fluid compositions C, I-L, and N had a viscosity of less than or equal to 35 cP at −28 degrees Celsius. Cleaning fluid compositions I-L and N had a viscosity of less than or equal to 30 cP at −28 degrees Celsius.

Fluid compositions B, C, E, H, I and N have a flash point of at least 15 degrees Celsius. Fluid compositions B, C, E, H and N have a flash point of at least 20 degrees Celsius. Fluid compositions B, C, H, and N have a flash point of at least 25 degrees Celsius. Fluid composition N has a flash point of at least 30 degrees Celsius.

Various aspects of the invention according to the present disclosure include, but are not limited to, the aspects listed in the following numbered clauses.
1. A cleaning fluid composition comprising:
   (a) 10% to 50% by weight of an alcohol based on the total weight of the fluid composition, wherein the fluid composition is substantially free of methanol;
   (b) 2% to 40% by weight of a co-solvent based on the total weight of the fluid composition, wherein the co-solvent is miscible with water and the fluid composition is substantially free of ethylene glycol; and
   (c) at least 20% by weight of water based on the total weight of the fluid composition;
   wherein the fluid composition has a viscosity less than or equal to 45 cP at −25 degrees Celsius and a freezing point of less than −25 degrees Celsius.
2. The fluid composition of clause 1, wherein the fluid composition is essentially free of methanol.
3. The fluid composition of any one of clauses 1-2, wherein the fluid composition is essentially free of ethylene glycol.
4. The fluid composition of any one of clauses 1-3, wherein the co-solvent comprises at least one of a glycol ether and a ketone.
5. The fluid composition of any one of clauses 1-4, wherein the co-solvent comprises at least one of methyl ethyl ketone, propylene glycol n-butyl ether, and dipropylene glycol dimethyl ether.
6. The fluid composition of any one of clauses 1-5, wherein the alcohol comprises at least one of ethanol, 1-propanol, and 2-propanol.
7. The fluid composition of any one of clauses 1-6, further comprising 0.1% to 5% by weight of ammonia based on the total weight of the fluid composition.
8. The fluid composition of any one of clauses 1-7, further comprising 1% to 20% by weight of a salt based on the total weight of the fluid composition.
9. The fluid composition of any one of clauses 1-8, wherein the fluid composition has a freezing point of less than −28 degrees Celsius and a viscosity less than or equal to 35 cP at −28 degrees Celsius.
10. The fluid composition of any one of clauses 1-9, wherein the fluid composition comprises 25% to 40% by weight of the alcohol based on the total weight of the fluid composition.
11. The fluid composition of any one of clauses 1-10, wherein the fluid composition comprises one of 25% to 35% by weight of the co-solvent based on the total weight of the fluid composition and 5% to 20% by weight of the co-solvent based on the total weight of the fluid composition.
12. The fluid composition of any one of clauses 1-11, wherein the fluid composition comprises 30% to 60% by weight of water based on the total weight of the fluid composition.
13. A method for manufacture of a cleaning fluid composition according to any one of clauses 1-12, the method comprising:
   (a) adding 10% to 50% by weight of an alcohol based on the total weight of the fluid composition;
   (b) adding at least 20% by weight of water based on the total weight of the fluid composition; and
   (c) adding 2% to 40% by weight of a co-solvent based on the total weight of the fluid composition, wherein the co-solvent is miscible with water.
14. The method of clause 13, further comprising adding at least one of 0.1% to 5% by weight of ammonia based on the total weight of the fluid composition and 1% to 20% by weight of a salt based on the total weight of the fluid composition to the fluid composition.
15. A cleaning method comprising applying a cleaning fluid composition according to any one of clauses 1 -12 to a surface.
16. Use of a cleaning fluid composition according to any one of clauses 1-12 as a windscreen washing fluid or defrosting fluid.

One skilled in the art will recognize that the herein described compositions, methods, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

Whereas particular examples of this invention have been described above for purposes of illustration, it will be evident to those skilled in the art that numerous variations of the details of the present invention may be made without departing from the invention as defined in the appended claims. For example, various other ketones, glycol ethers, salts, alcohols, and addition components in addition to the ones used in the Examples, could be employed in a cleaning fluid composition of the present invention.

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

Although various examples have been described herein, many modifications, variations, substitutions, changes, and equivalents to those examples may be implemented and will occur to those skilled in the art. Also, where materials are disclosed for certain components, other materials may be used. It is therefore to be understood that the foregoing description and the appended claims are intended to cover all such modifications and variations as falling within the scope of the disclosed examples. The following claims are intended to cover all such modification and variations.

Any patent, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

In summary, numerous benefits have been described which result from employing the concepts described herein. The foregoing description of the one or more examples has been presented for purposes of illustration and description. It is not intended to be exhaustive or limiting to the precise form disclosed. Modifications or variations are possible in light of the above teachings. The one or more examples were chosen and described in order to illustrate principles and practical application to thereby enable one of ordinary skill in the art to utilize the various examples and with various modifications as are suited to the particular use contemplated. It is intended that the claims submitted herewith define the overall scope.

While the present disclosure provides descriptions of various specific aspects for the purpose of illustrating various aspects of the present disclosure and/or its potential applications, it is understood that variations and modifications will occur to those skilled in the art. Accordingly, the invention or inventions described herein should be understood to be at least as broad as they are claimed, and not as more narrowly defined by particular illustrative aspects provided herein.

What is claimed is:

1. A cleaning fluid composition comprising:
(a) 10% to 50% by weight of an alcohol based on the total weight of the fluid composition, wherein the fluid composition is substantially free of methanol;
(b) 2% to 40% by weight of a co-solvent based on the total weight of the fluid composition, wherein the co-solvent is miscible with water and the fluid composition is substantially free of ethylene glycol; and
(c) at least 20% by weight of water based on the total weight of the fluid composition;
wherein the fluid composition has a viscosity less than or equal to 45 cP at −25 degrees Celsius and a freezing point of less than −25 degrees Celsius.

2. The fluid composition of claim 1, wherein the fluid composition is essentially free of methanol.

3. The fluid composition of claim 1, wherein the fluid composition is essentially free of ethylene glycol.

4. The fluid composition of claim 1, wherein the co-solvent comprises at least one of a glycol ether and a ketone.

5. The fluid composition of claim 1, wherein the co-solvent comprises at least one of methyl ethyl ketone, propylene glycol n-butyl ether, and dipropylene glycol dimethyl ether.

6. The fluid composition of claim 1, wherein the alcohol comprises at least one of ethanol, 1-propanol, and 2-propanol.

7. The fluid composition of claim 1, further comprising 0.1% to 5% by weight of ammonia based on the total weight of the fluid composition.

8. The fluid composition of claim 1, further comprising 1% to 20% by weight of a salt based on the total weight of the fluid composition.

9. The fluid composition of claim 1, wherein the fluid composition has a freezing point of less than −28 degrees Celsius and a viscosity less than or equal to 35 cP at −28 degrees Celsius.

10. The fluid composition of claim 1, wherein the fluid composition comprises 25% to 40% by weight of the alcohol based on the total weight of the fluid composition.

11. The fluid composition of claim 1, wherein the fluid composition comprises one of 25% to 35% by weight of the co-solvent based on the total weight of the fluid composition and 5% to 20% by weight of the co-solvent based on the total weight of the fluid composition.

12. The fluid composition of claim 1, wherein the fluid composition comprises 30% to 60% by weight of water based on the total weight of the fluid composition.

13. A method for manufacture of a cleaning fluid composition, the method comprising:
(a) adding 10% to 50% by weight of an alcohol based on the total weight of the fluid composition;
(b) adding at least 20% by weight of water based on the total weight of the fluid composition; and
(c) adding 2% to 40% by weight of a co-solvent based on the total weight of the fluid composition, wherein the co-solvent is miscible with water,
wherein the fluid composition is substantially free of ethylene glycol and methanol and the fluid composition has a viscosity less than or equal to 45 cP at −25 degrees Celsius and a freezing point less than −25 degrees Celsius.

14. The method of claim 13, wherein the fluid composition is essentially free of at least one of methanol and ethylene glycol.

15. The method of claim 13, wherein the co-solvent comprises at least one of a glycol ether and a ketone.

16. The method of claim 13, wherein the co-solvent comprises at least one of methyl ethyl ketone, propylene glycol n-butyl ether, and dipropylene glycol dimethyl ether.

17. The method of claim 13, wherein the alcohol comprises at least one of ethanol, 1-propanol, and 2-propanol.

18. The method of claim 13, further comprising adding at least one of 0.1% to 5% by weight of ammonia based on the total weight of the fluid composition and 1% to 20% by weight of a salt based on the total weight of the fluid composition to the fluid composition.

19. The method of claim 13, wherein the fluid composition has a freezing point of less than −28 degrees Celsius and a viscosity less than or equal to 30 cP at −28 degrees Celsius.

20. A cleaning method comprising:
(i) applying a cleaning fluid composition to a surface of a substrate, the fluid composition comprising:
(a) 10% to 50% by weight of an alcohol based on the total weight of the fluid composition, wherein the fluid composition is substantially free of methanol;
(b) 2% to 40% by weight of a co-solvent based on the total weight of the fluid composition, wherein the co-solvent is miscible with water and the fluid composition is substantially free of ethylene glycol; and
(c) at least 20% by weight of water based on the total weight of the fluid composition; and
wherein the fluid composition has a viscosity less than or equal to 45 cP at −25 degrees Celsius and a freezing point less than −25 degrees Celsius.
